(19) United States
(12) Patent Application Publication
(10) Pub. No.: US 2026/0141028 A1
(43) Pub. Date: May 21, 2026

(54) SYSTEM AND METHOD FOR ELABORATING A MACHINE LEARNING MODEL FOR CLASSIFICATION OF TIME SERIES SIGNALS

(71) Applicant: STMicroelectronics International N.V., Geneva (CH)

(72) Inventor: He Huang, Paris (FR)

(21) Appl. No.: 19/182,107

(22) Filed: Apr. 17, 2025

(30) Foreign Application Priority Data
May 3, 2024 (FR) FR2404669

(51) Int. Cl. G06F 18/214; G06F 18/2113; G06F 123/02

(52) U.S. Cl. CPC G06F 18/214; G06F 18/2113; G06F 2123/02; G06F 2218/08

(57) ABSTRACT

According to one aspect, a method for elaborating a machine learning model for the classification of time series signals is proposed comprising obtaining features of training time series signals associated with different indicated classes, calculating a distinction coefficient between classes for each feature and calculating a distinction coefficient between classes for each combination of features from a distribution of the values of the features for each group of time series signals, ranking the features according to the distinction coefficient of each feature and the distinction coefficient of each combination of features, and training the machine learning model by taking as input for this model at least one feature chosen according to the ranking.

### CROSS-REFERENCED TO RELATED APPLICATION

This application claims the benefit of French Patent Application No. 2404669, filed on May 3, 2024, which application is hereby incorporated herein by reference.

### TECHNICAL FIELD

Embodiments and implementations relate to the elaboration of machine learning models for the classification of time series signals.

### BACKGROUND

A time series signal is a set of data points acquired, for example by means of a sensor, at successive time intervals, notably at regular intervals. Each data point of a time series represents the status or the measurement of a phenomenon observed at a precise moment.

The classification of time series signals consists in attributing a class (notably a label or a category) to each time series as a function of its features. Such a classification may be important in numerous fields, such as gesture recognition, health surveillance, finance and meteorology, because it makes it possible to identify specific behaviors or states from time data.

The classification of time series signals may be based on statistical or structural features of time series, such as the average, the variance, the trend, or the dominant frequencies, and uses these features as input for classifiers.

In particular, in order to classify time series signals, it is possible to use machine learning models. For example, these machine learning models may implement algorithms such as random forests, decision trees, support vector machines and artificial neural networks.

Such machine learning models use supervised learning. The learning model is trained from a set of time series signals already classified. The time series signals are associated with different classes.

A class represents a group of time series signals having a same label.

For example, a group of time series signals may be associated with a class corresponding to normal time series signals, and another group of time series signals may be associated with a class corresponding to anomalies.

The time series signals may be used directly as input for the machine learning model. In an alternative, it is possible to use only values of certain features extracted from the time series signal as input for the machine learning model.

The use of values of these features as input for the machine learning model makes it possible to simplify the learning model, by reducing the number of input points of the learning model, and generally makes it possible to improve its performances, notably if the features are well chosen.

Solutions making it possible to extract different features as input for the machine learning model are notably known. On account of the number of possible features being able to be extracted, it is important to determine which are the features making it possible to obtain better classification results.

In particular, several solutions exist making it possible to select certain features to use as input for the machine learning model. It is for example possible to eliminate features having a low variance. It is also possible to select features by performing tests F to analyze the variance (ANOVA). It is also possible to select features by chi-square tests. These solutions may not be optimal in the selection of features to use as input for the machine learning model.

Other solutions make it possible to select features during the training of the machine learning model. It is for example possible to add or remove features to take as input for the machine learning model then to test the performances of the machine learning model obtained after its training. These solutions require a configuration of the machine learning model which may prove complex and very time consuming. These solutions may be costly in calculation time and may require large amounts of data. They may also lead to overfitting to the learning data and selecting unnecessary features.

There exists therefore a need to propose a solution making it possible to select simply and in a relevant manner the features to take as input for a machine learning model for the classification of time series signals.

### SUMMARY

According to one aspect, a computer implemented method for elaborating a machine learning model for the classification of time series signals is proposed comprising:
obtaining features of training time series signals, the training time series signals being grouped into at least two groups of time series signals, each group of time series signals being associated with an indicated class,
defining several combinations of features,
calculating a distinction coefficient between classes for each feature from a distribution of the values of this feature for each group of time series signals,
calculating a distinction coefficient between classes for each combination of features from a distribution of the values of this combination of features for each group of time series signals,
ranking the features according to the distinction coefficient of each feature and the distinction coefficient of each combination of features, and
training the machine learning model taking as input for this model at least one feature chosen according to the ranking.

Such a method is relatively quick and efficient for evaluating the relevance of each feature and of each combination of features. The features are classified not only from the relevance of each feature but also from the relevance of each combination of features. This makes it possible to select in a relevant manner the features to take as input for the machine learning model. In this way, the performances of the machine learning model may be improved.

Such a method makes it possible to select the features to use as input for the learning model. This selection is done in such a way as to offer a compromise between autonomy, precision, efficiency and reliability, which makes it a versatile and reliable approach for numerous classification tasks.

Further, such a method makes it possible to control the number of features to use as input for the machine learning model, in such a way as to limit the memory and calculation resources for the storage and execution of the machine learning model.

In an advantageous embodiment, the distribution of the values of a feature for each group of time series signals is evaluated from a histogram for each group of time series signals, the histogram counting, for different ranges of defined values, a number of time series signals of the group having a value for this feature comprised in each range of defined values.

The use of histograms makes it possible to avoid overfitting to the time series signals used for training. In particular, the number of ranges of values of the histogram is linked to the number of time series signals. This number of ranges of values is for example determined by a Sturges rule. This makes it possible to avoid having a limited number of ranges of values to avoid overfitting.

Preferably, the calculation of a distinction coefficient between classes for a feature comprises:
calculating a distinction index of this feature by summating the number of time series signals of the group of time series signals the most represented for each range of vales of this feature, and
dividing this distinction index by the total number of time series signals to obtain the distinction coefficient.

Advantageously, the calculation of a distinction coefficient between classes for a combination of features comprises:
calculating a distinction index of this combination of features by summating the number of time series signals of the group the most represented for each combination of ranges of values, each combination of ranges of values being formed from a range of values for each feature of the combination of features, and
dividing this distinction index by the total number of time series signals to obtain the distinction coefficient.

According to another aspect, a computer program product is proposed comprising instructions which, when the program is executed by a computer, result in the latter implementing a method for elaborating a machine learning model as described previously.

According to another aspect, an information system is proposed comprising:
a non-transitory memory configured to store a computer program product as described previously as well as the features of time series signals to elaborate a machine learning model for the classification of such time series signals, and
a processor or processing unit configured to execute the computer program product.

According to another aspect, a computer readable data support is proposed, in which the computer program product as described previously is saved.

### BRIEF DESCRIPTION OF THE DRAWINGS

Other advantages and features of the invention will become apparent upon reading the detailed description of embodiments, which are in no way limiting, and from the appended drawings in which:

FIG. 1 illustrates an information system for elaborating a machine learning model for the classification of time series signals;

FIG. 2 method for elaborating a machine learning model for the classification of time series signals;

FIG. 3 illustrates an exemplary graph representing two histograms associated with two classes of time series signals for a studied feature; and

FIG. 4 illustrates a distribution graph of time series signals of two classes for two features.

### DETAILED DESCRIPTION OF ILLUSTRATIVE EMBODIMENTS

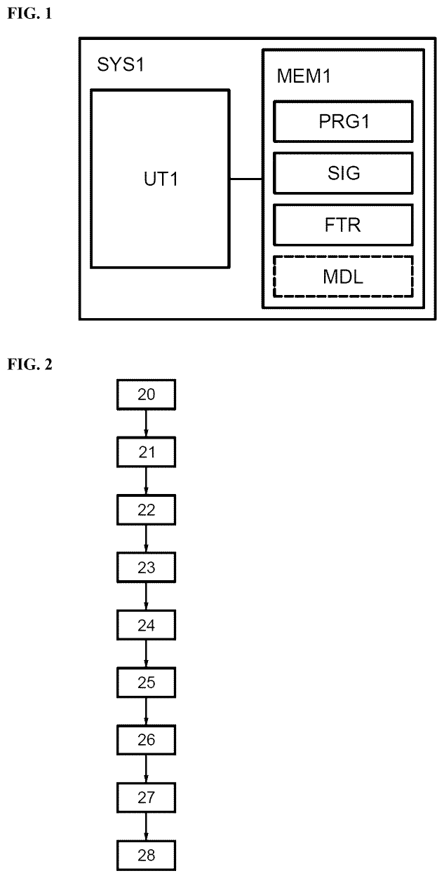

FIG. 1 illustrates an embodiment of an information system SYS1 configured to implement a method for elaborating a machine learning model for the classification of time series signals, as described hereafter in relation with FIG. 2.

The information system SYS1 comprises a processor or processing unit UT1 and a non-transitory memory MEM1. Such an information system SYS1 may be a personal computer or instead a server for example.

The non-transitory memory MEM1 includes a computer program PRG1 comprising instructions which, when the program PRG1 is executed by a processor or processing unit UT1 of the information system SYS1, result in the latter implementing the method for generating a machine learning model.

The non-transitory memory MEM1 is also configured to store time series signals SIG used for the training of the machine learning model. The time series signals SIG are supplied by a user of the information system SYS1 wishing to elaborate a machine learning model for the classification of time series signals.

The time series signals SIG may be obtained from data acquired by sensors then supplied to the information system SYS1. The time series signals SIG may for example correspond to any type of analogue or digital signal, for example vibration signals, current measurements, etc.

The time series signals SIG used for the training of the machine learning model include signals associated with different classes.

A class represents a group of time series signals having a same label.

For example, a group of time series signals may be associated with a class corresponding to normal time series signals, and another group of time series signals may be associated with a class corresponding to anomalies.

Here, the time series signals are distributed in two groups of time series signals. Nevertheless, it is possible to provide more than two groups of time series signals.

More particularly, the features FTR of the time series signals are quantitative measurements or properties of the time series signals that make it possible to distinguish them from each other and to associate them with particular classes. The features FTR may be extracted from the time series signals by measuring them or by calculating them. These features may be stored in the non-transitory memory MEM1.

The processor or processing unit UT1 is configured to elaborate a machine learning model MDL by implementing the elaboration method described hereafter. In particular, the processor or processing unit UT1 is configured to elaborate a machine learning model MDL by executing the computer program PRG1 from the time series signals SIG.

FIG. 2 illustrates an implementation of a method for elaborating a machine learning model for the classification of time series signals. Such an elaboration method may be executed by an information system as described previously.

The method comprises obtaining 20 time series signals SIG associated with different classes. Each class is thus defined by a group of time series signals. The time series signals may be acquired from sensors.

The method comprises a definition 21 of at least one feature FTR of the time series signals to study to classify these time series signals. These features are defined by the user. These features may be statistical or structural features.

The features FTR of the time series signals may comprise amplitudes, frequencies, durations, minimums, maximums, averages, standard deviations, a rapid Fourier transform peak, a rapid Fourier transform energy, line integral, an entropy, a number of passages through an average value, etc.

The method next comprises an extraction 22 of the values of the features FTR of the time series signals used for the training of the machine learning model. Different techniques may be implemented to extract these features from the time series signals. It is for example possible to use a sliding time window, a wavelet transform or a Fourier transform on each time series signal. The choice of the technique to implement to extract a feature of a time series signal depends on the type of this feature.

In an alternative, it is possible for the user to provide directly features of time series signals.

At least one part of the studied features is intended to be used as input for the machine learning model. The values of the extracted features thus serve as learning data for the training of the machine learning model.

The method also comprises a definition 23 of different combinations of studied features. For example, each combination of features is constituted of two features. Nevertheless, it is possible to provide combinations of features constituted of more than two features.

The method next comprises an elaboration 24 of a histogram for each studied feature and for each class of time series signals. This makes it possible to study the distribution of the values of each studied feature for the different classes.

Each histogram associated with a studied feature is elaborated from ranges of values defined for this feature.

In particular, the ranges of values may be defined by clipping of values extracted from the time series signals. The ranges of values may for example be defined using the Sturges rule or the Freedman-Diaconis rule or the Scott rule, well known to those skilled in the art. The number of ranges of values defines a granularity of the analysis of the distribution of the values of each studied feature.

Each histogram is used to count, for each range of values defined for the studied feature, a number of time series signal of a class having a value associated with the studied feature comprised in the range of values. A histogram thus has bins associated with the different ranges of defined values. Each bin then illustrates the number of occurrences of time series signals of the class associated with this histogram for the range of values of the studied feature associated with this bin.

The histogram may be stored in a non-transitory memory MEM1 in table form. Each box of the table is then associated with a range of values and with a number of occurrences of time series signals of a class having a value for this feature comprised in this range of values.

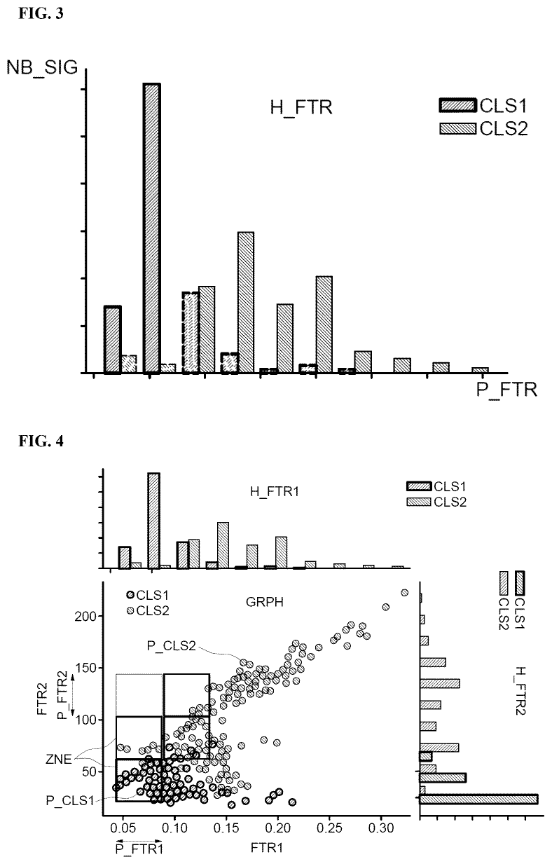

FIG. 3 illustrates an exemplary graph H_FTR representing two histograms associated with two classes CLS1, CLS2 of time series signals for a studied feature. The number of occurrences NB_SIG are illustrated on the Y-axis and the ranges of vales are illustrated on the X-axis. In order to distinguish the two histograms, the histogram associated with the class CLS1 has thicker contours than the contours of the histogram associated with the class CLS2. For each value range, the contour of the highest bin of the histograms is in solid line, and the contour of the least high bin of the histograms is segmented.

The histograms are used to analyze the distribution of the time series signals of each class for the different studied features as well as for the different combinations of defined features. This analysis makes it possible to determine which features enable the different classes of time series signals to be better distinguished.

In particular, the method next comprises calculating 25 a distinction coefficient for each studied feature.

To calculate this distinction coefficient, the method comprises a comparison between the histograms of the different classes of time series signals for each studied feature.

Thus, for each range of values, the number of occurrences of time series signals having a value in this range of values is compared between each class.

The largest number of occurrences is then added to a distinction index. Consequently, for each range of values, only the number of occurrences of signals of the most represented class is conserved and summated to obtain the distinction index. For example, in FIG. 3, the number of occurrences retained for each range of values is represented in solid line and the number of occurrences not retained for each range of values is represented in broken line.

The distinction index is thus obtained by the following mathematical formula:

$$[ IND ] \_sgl = {\sum }_{-} ( j = 0 ) \hat{} ( m - 1 ) ≡ [ max ( ⊣ ] [ OCC ] \_x ( j ) ; [ OCC ] \_y ( j ) ) ,$$

where OCCₓ (j) is the number of occurrences of time series signals of the class x having a value of the studied feature in the range j of values, and OCC_{y} (j) is the number of occurrences of time series signals of the class y having a value of the studied feature in the range j of values, n ranges of values being defined for the studied feature.

The distinction coefficient of a studied feature is calculated by dividing the distinction index by the number of time series signals.

Thus, the distinction coefficient of a studied feature is obtained by the mathematical formula:

$${COEF}_{s g l} = \frac{{IND}_{s g l}}{N {B}_{D A T}} ,$$

where IND_{sgl} is the distinction index calculated for the studied feature and NB_DAT is the total number of time series signals of the different classes.

The method also comprises a calculation 26 of distinction coefficients for different combinations of features. The calculation of these distinction coefficients uses the histograms elaborated previously for each studied feature and for each class.

In particular, for each defined combination of features, the method comprises a comparison 27 between the histograms of the different classes of time series signals elaborated for each feature of the combination.

For example, FIG. 4 illustrates a distribution graph GRPH of time series signals of two classes CLS1 and CLS2 for two features FTR1 and FTR2. The distribution graph is obtained from graphs of histograms H_FRT1 and H_FRT2 elaborated for the features FRT1 and FRT2 respectively. The distribution graph illustrates zones ZNE having as dimensions the widths of ranges of values P_FTR1 and P_FTR2 of the features FTR1 and FTR2 respectively.

For each combination of ranges of values of the features of each studied combination of features, the number of occurrences of time series signals having values in this combination of ranges of values is compared between each class. For example, in FIG. 4, the number of occurrences of time series signals of the two classes CLS1 and CLS2 in each zone ZNE are compared.

The highest number of occurrences is then added to a distinction index for this combination of features. Thus, for each range of values only the number of occurrences of signals of the most represented class is conserved and summated to obtain the distinction index for this combination of features.

The distinction index for a combination of two features is thus obtained by the following mathematical formula:

$${IND}_{c o m b} = {\sum }_{j = 0}^{n - 1} {\sum }_{k = 0}^{m - 1} max ( {OCC}_{x} ( j , k ) ; {OCC}_{y} ( j , k ) ) ,$$

where j corresponds to a range of values of a first feature of the studied combination of features, k corresponds to a range of values of a second feature of the studied combination of features, OCCₓ (j, k) is the number of occurrences of time series signals of the class x having values for the features of the studied combination in the ranges j and k of values, and OCC_{y}(j, k) is the number of occurrences of time series signals of the class x having values for the features of the studied combination in the ranges j and k of values, n ranges of values being defined for the first feature, and m ranges of values being defined for the second feature.

Thus, the distinction coefficient of a combination of features is obtained by the mathematical formula:

$${COEF}_{c o m b} = \frac{{IND}_{c o m b}}{N {B}_{D A T}} ,$$

where IND_{comb} is the distinction index calculated for the studied combination of features and NB_DAT is the total number of time series signals of the different classes.

The distinction coefficient COEF_{sgl} of each feature makes it possible to evaluate the relevance of each feature to distinguish the different classes and to select the most relevant features.

The distinction coefficient COEF_{comb} of each combination of features makes it possible to evaluate the relevance of each combination of features to distinguish the different classes and to select the most relevant combinations of features.

More particularly, the method comprises a ranking 27 of the studied features according to the distinction coefficient COEF_{sgl} of each feature and the distinction coefficient COEF_{comb} of each combination of features.

The higher the distinction coefficient COEF_{sgl} of a feature, the higher will be the rank of this feature. Further, the higher a distinction coefficient COEF_{comb} of a combination of features, the higher will be the rank of these features.

The correlation between the features is also taken into account in the ranking of the features. In particular, the ranking is adjusted as a function of the best performances, reduced by a correlation factor for the best classed features. The correlation factor is less than 10%, for example of the order of 5%. This makes it possible to select the most relevant features while avoiding redundancy and overfitting.

Next, the method comprises training 28 of a machine learning model for the classification of time series signals acquired by a sensor such as that described previously. The machine learning model may comprise algorithms such as random forests and decision trees, support vector machines and artificial neural networks.

The training of the machine learning model is performed using as input for the machine learning model at least one studied feature and chosen as a function of the ranking established previously.

More particularly, the user defines a number of features as hyperparameter for the training of the machine learning model. Thus, the number of features taken as input for the machine learning model may vary during the training of the machine learning model. The features taken as input for the machine learning model are defined from their ranking, starting from the best rank (i.e. the highest rank). The use of the ranking of the features makes it possible to limit the use of non-transitory memory and calculation resources while avoiding using features not enabling the classes to be sufficiently distinguished. This therefore makes it possible to improve the efficiency and the performances of the machine learning model.

The training of the machine learning model is performed in a supervised manner. In particular, during training, the machine learning model learns to classify the time series signals by comparing the classification obtained as output of the machine learning model with the class corresponding to the time series signal taken as input. This is done by adjusting internal parameters of the model (for example, the weightings in a neural network) to minimize a cost or loss function, which measures the difference between the classification obtained as output of the machine learning model and the class of each time series signal received as input.

Next, at the end of the training of the machine learning model, these performances are evaluated to verify its ability to classify time series signals.

It is next possible to perform again the training of the machine learning model by using other hyperparameters, notably by modifying the number of features to take as input for the machine learning model.

Such a method is relatively quick and efficient for evaluating the relevance of each feature and of each combination of features. The features are classified not only from the relevance of each feature but also from the relevance of each combination of features. This makes it possible to select in a relevant manner the features to take as input for the machine learning model. In this way, the performances of the machine learning model may be improved. The implementation of such a method makes it possible to avoid for the user an in-depth adjustment of the hyperparameters and a definition of a specific machine learning model for the selection of features.

Further, such a method makes it possible to control the number of features to use as input for the machine learning model, in such a way as to limit the non-transitory memory and calculation resources for the storage and execution of the machine learning model.

Such a method makes it possible to select the features to use as input for the learning model. This selection is done in such a way as to offer a compromise between autonomy, precision, efficiency and reliability, which makes it a versatile and reliable approach for numerous classification tasks.

As discussed above, the microcontroller or processor in the sensor collects and processes directly time series data from various sensors and makes real-time decisions at the edge that result in physical changes in the real world. The types of sensors include accelerometer sensors, current sensors, and magnetic sensors. In a specific application, the sensors are configured to collect the time series data using the implementation-appropriate sampling rates, data preprocessing steps, and filtering techniques. Several example applications are provided below.

In a first example, an accelerometer sensor integrated with a microcontroller detects unusual vibrations in machinery. Based on the real-time analysis, the system can automatically adjust the machinery's operation to prevent potential failures or trigger an alert for maintenance personnel.

In a second example, a current sensor in an electrical system monitors power usage and detects anomalies. The microcontroller can then take actions such as shutting down specific circuits to prevent overload or fire hazards.

In a third example, a magnetic sensor embedded in a security system detects unauthorized access attempts. The processor can trigger physical security measures such as locking doors or activating alarms.

The use of histograms makes it possible to avoid overfitting to the time series signals used for training. The use of histograms also makes it possible to reduce the calculation time to select the features to use, notably when the number of time series signal is significant.

What is claimed is:

1. A computer implemented method for elaborating a machine learning model for classification of time series signals, the method comprising:
obtaining features of training the time series signals, the training the time series signals being grouped into at least two groups of time series signals, each group of time series signals being associated with an indicated class;
defining several combinations of features;
calculating a distinction coefficient between classes for each feature from a distribution of values of the feature for each group of time series signals;
calculating a distinction coefficient between classes for each combination of features from a distribution of values of the combination of features for each group of time series signals;
ranking the features according to the distinction coefficient between the classes for each feature and the distinction coefficient between the classes for each combination of features; and
training the machine learning model by taking as input for the model at least one feature chosen according to the ranking.

2. The method according to claim 1, wherein the distribution of the values of the feature for each group of time series signals is evaluated from a histogram for each group of time series signals, the histogram counting, for different ranges of defined values, a number of time series signals in the respective group having a value for the feature contained in each range of defined values.

3. The method according to claim 2, wherein the calculating the distinction coefficient between the classes for a given feature comprises:
calculating a distinction index of the feature by summating a number of time series signals of the group of time series signals most represented for each range of vales of the feature; and
dividing the distinction index by a total number of time series signals to obtain the distinction coefficient between the classes for the given feature.

4. The method according to claim 3, wherein the calculating the distinction coefficient between the classes for a given combination of features comprises:
calculating a distinction index of the combination of features by summating a number of time series signals of the group most represented for each combination of ranges of values, each combination of ranges of values being formed from a range of values for each feature of the combination of features; and
dividing the distinction index by the total number of time series signals to obtain the distinction coefficient between the classes for the given combination of features.

5. The method according to claim 2, wherein the calculating the distinction coefficient between the classes for a given combination of features comprises:
calculating a distinction index of the combination of features by summating a number of time series signals of the group most represented for each combination of ranges of values, each combination of ranges of values being formed from a range of values for each feature of the combination of features; and
dividing the distinction index by a total number of time series signals to obtain the distinction coefficient between the classes for the given combination of features.

6. The method according to claim 1, further comprising obtaining the values for each feature of each time series signal using a technique selected from the group consisting of: a sliding time window, a wavelet transform, a Fourier transform, and combinations thereof.

7. The method according to claim 1, wherein the features are selected from the group consisting of: amplitudes, frequencies, durations, minimums, maximums, averages, standard deviations, rapid Fourier transform peaks, rapid Fourier transform energies, line integrals, entropies, numbers of passages through an average value, and combinations thereof.

8. A computer program product comprising instructions which, when the program is executed by a computer, causes the computer to implement a method for elaborating a machine learning model for classification of time series signals, the method comprising:
obtaining features of training the time series signals, the training the time series signals being grouped into at least two groups of time series signals, each group of time series signals being associated with an indicated class;
defining several combinations of features;
calculating a distinction coefficient between classes for each feature from a distribution of values of the feature for each group of time series signals;
calculating a distinction coefficient between classes for each combination of features from a distribution of values of the combination of features for each group of time series signals;
ranking the features according to the distinction coefficient between the classes for each feature and the distinction coefficient between the classes for each combination of features; and
training the machine learning model by taking as input for the model at least one feature chosen according to the ranking.

9. The computer program product according to claim 8, wherein the distribution of the values of the feature for each group of time series signals is evaluated from a histogram for each group of time series signals, the histogram counting, for different ranges of defined values, a number of time series signals in the respective group having a value for the feature contained in each range of defined values.

10. The computer program product according to claim 9, wherein the calculating the distinction coefficient between the classes for a given feature comprises:
calculating a distinction index of the feature by summating a number of time series signals of the group of time series signals most represented for each range of vales of the feature; and
dividing the distinction index by a total number of time series signals to obtain the distinction coefficient between the classes for the given feature.

11. The computer program product according to claim 10, wherein the calculating the distinction coefficient between the classes for a given combination of features comprises:
calculating a distinction index of the combination of features by summating a number of time series signals of the group most represented for each combination of ranges of values, each combination of ranges of values being formed from a range of values for each feature of the combination of features; and
dividing the distinction index by the total number of time series signals to obtain the distinction coefficient between the classes for the given combination of features.

12. The computer program product according to claim 9, wherein the calculating the distinction coefficient between the classes for a given combination of features comprises:
calculating a distinction index of the combination of features by summating a number of time series signals of the group most represented for each combination of ranges of values, each combination of ranges of values being formed from a range of values for each feature of the combination of features; and
dividing the distinction index by a total number of time series signals to obtain the distinction coefficient between the classes for the given combination of features.

13. The computer program product according to claim 8, wherein the method further comprises obtaining the values for each feature of each time series signal using a technique selected from the group consisting of: a sliding time window, a wavelet transform, a Fourier transform, and combinations thereof.

14. The computer program product according to claim 8, wherein the features are selected from the group consisting of: amplitudes, frequencies, durations, minimums, maximums, averages, standard deviations, rapid Fourier transform peaks, rapid Fourier transform energies, line integrals, entropies, numbers of passages through an average value, and combinations thereof.

15. An information system comprising:
a non-transitory memory configured to store a computer program product as well as features of time series signals to elaborate a machine learning model for classification of the time series signals; and
a processor communicatively coupled to the non-transitory memory and configured to execute the computer program product to:
obtain the features of training the time series signals, the training the time series signals being grouped into at least two groups of time series signals, each group of time series signals being associated with an indicated class;
define several combinations of features;
calculate a distinction coefficient between classes for each feature from a distribution of values of the feature for each group of time series signals;
calculate a distinction coefficient between classes for each combination of features from a distribution of values of the combination of features for each group of time series signals;
rank the features according to the distinction coefficient between the classes for each feature and the distinction coefficient between the classes for each combination of features; and
train the machine learning model by taking as input for the model at least one feature chosen according to the ranking.

16. The information system according to claim 15, wherein the distribution of the values of the feature for each group of time series signals is evaluated from a histogram for each group of time series signals, the histogram counting, for different ranges of defined values, a number of time series signals in the respective group having a value for the feature contained in each range of defined values.

17. The information system according to claim 16, wherein the processor configured to execute the computer program product to calculate the distinction coefficient between the classes for a given feature comprises the processor executing the computer program product to:
calculate a distinction index of the feature by summating a number of time series signals of the group of time series signals most represented for each range of vales of the feature; and
divide the distinction index by a total number of time series signals to obtain the distinction coefficient between the classes for the given feature.

18. The information system according to claim 17, wherein the processor configured to execute the computer program product to calculate the distinction coefficient between the classes for a given combination of features comprises the processor executing the computer program product to:
calculate a distinction index of the combination of features by summating a number of time series signals of the group most represented for each combination of ranges of values, each combination of ranges of values being formed from a range of values for each feature of the combination of features; and
divide the distinction index by the total number of time series signals to obtain the distinction coefficient between the classes for the given combination of features.

19. The information system according to claim 16, wherein the processor configured to execute the computer program product to calculate the distinction coefficient between the classes for a given combination of features comprises the processor executing the computer program product to:
calculate a distinction index of the combination of features by summating a number of time series signals of the group most represented for each combination of ranges of values, each combination of ranges of values being formed from a range of values for each feature of the combination of features; and
divide the distinction index by a total number of time series signals to obtain the distinction coefficient between the classes for the given combination of features.

20. The information system according to claim 15, wherein the features are selected from the group consisting of: amplitudes, frequencies, durations, minimums, maximums, averages, standard deviations, rapid Fourier transform peaks, rapid Fourier transform energies, line integrals, entropies, numbers of passages through an average value, and combinations thereof.
